(19) United States
(12) Patent Application Publication
(10) Pub. No.: US 2008/0245191 A1
(43) Pub. Date: Oct. 9, 2008

(54) Device for opening and sealing a beverage can lid

(76) Inventor: Robert Bailly, Costa Mesa, CA (US)

Correspondence Address: Robert Bailly, 575 W. 19th Street Apt. H281, Costa Mesa, CA, 92627, US

(21) Appl. No.: 11/696,714

(22) Filed: Apr. 4, 2007

(51) Int. Cl. B67B 7/44

(52) U.S. Cl. 81/3.15

(57) ABSTRACT

A device for opening and re-sealing a flip-tab beverage can lid includes a pull handle connected with a base portion. The base portion is tapered and further comprises an upper and lower base portion. The pull handle facilitates the opening of the lid and the base portion is configured to cover and optionally seal the lid opening. A sleeve portion is contained within the base portion and is configured to receive the flip-tab of a beverage can lid. The beverage can lid is opened by lifting the pull handle away from lid surface to cause a tab lip of the flip-tab to rotate towards the lid surface and act as a lever to punch out a swinging seal in the lid surface that is defined by a scored area. The pull handle further facilitates rotation of the base portion about the lid surface and into a covering position that covers the lid opening and keeps the can contents free from outside contaminants. The base portion can then be depressed into a sealing position that seals the lid opening and substantially eliminates the loss of carbonation from the beverage can. The device is held in the sealing position by a ridge that spans the perimeter of the lower base portion and hold the device firmly against the lid opening and lid surface. The device can be taken out of the sealing position by lifting the pull handle. In this manner a user of the present invention can repeatedly open and re-seal the opening of a beverage can lid as desired.

### FIELD OF THE INVENTION

The present invention relates to devices for opening and re-sealing beverage can lids of the flip-tab variety.

### BACKGROUND OF THE INVENTION

Many types of beverages such as soda, beer, and juice are packaged and sold in cylindrical-shaped, closed-ended cans with “flip-tab” or “flip-tab” lids. This type of beverage container has become the standard in the beverage industry and provides for convenient storage, packaging, and transportation of beverages both individually and in bulk. Beverage cans are typically made of a metal such as aluminum, steel, tin, or other metal with the desired properties of being light weight, strong, resistance to corrosion, and capable of being easily manufactured to thin dimensions. The most common size of beverage can holds twelve (12) ounces of fluid, although other sizes exist in the industry, including the eight (8) ounce, sixteen (16) ounce, twenty (20) ounce, and twenty-four (24) ounce varieties.

Such cans include a circular lid with a circumferential lid rim and a scored section that defines a swinging seal. Opposing the circular lid is a circular base that also includes a circumferential base rim. The base and lid are connected by a thin, cylindrical-shaped wall. The cylindrical side wall tapers inward to form an axially outward circular rim around the lid and the base of the can. The lid and base rims on the can allow for easy stacking wherein the base of one can mates with the lid of another can, and so forth. The perimeter around the swinging seal is scored just enough so that the perimeter is weakened and the swinging seal can be easily punched out, while still providing an airtight seal that preserves the carbonation and prevents contamination. The swinging seal can be punched out by lifting a tab that is anchored to the lid by a rivet. When lifted, the tab rotates about the rivet and acts as a lever that punches out the scored section to form an opening. This opening allows the liquid within the can to be easily dispensed as desired. The tab is mounted to the lid surface such that there is only a small gap between the tab and the lid surface. Thus, in order to grasp the tab and perform the lever action required to punch out the swinging seal, the user must be able get their finger underneath the tab.

There are two main disadvantages that result from this can design. First, opening the can may be difficult because a user must often use their fingernail to get under the tab and lift it for opening. This is often burdensome because a user may have nails that are too short or too long for this purpose. If a user's nails are too short then they may not be able to get enough nail under the tab and will not generate enough leverage to lift the tab. Conversely, those with longer nails may be afraid to use their nails for leverage because there is a high probability that their nail would crack or break as in the process. Second, the opening process is irreversible and there is no convenient or effective way to close or re-seal the opening once the swinging seal has been punched out of the lid surface.

As described above, the traditional beverage can presents two problems. First, the flip-tab lid is often difficult for some users to open because a user must pry their fingernail under the tab in order to lift it and punch out the swinging seal. Secondly, the opening process is irreversible in that once the seal has been opened, the can cannot be re-sealed. As a result, the fluid contents of the can lose their carbonation and are easily susceptible to contamination from the environment. This problem is particularly acute where the user does not wish to consume the beverage all at once, but at their leisure, which would normally result in a substantially loss of carbonation. Moreover, the inability to reseal the opening in the lid is especially a problem where, for example, the can is exposed to an environment that contains many potential contaminants in the air or where there are many insects that are attracted to the can.

There is a need in the art for a simple, low-cost device that allows the user to overcome the aforementioned disadvantages that are inherent in conventional flip-tab or flip-tab beverage cans. The present invention provides a solution to these disadvantages and provides further related advantages as described below.

### SUMMARY OF THE INVENTION

These and other objects are achieved by the device of the present invention which allows a user to open and reseal a beverage can lid in a manner not provided in the prior art. The present invention provides a device for opening and re-sealing a flip-tab beverage can lid. The device includes a base portion configured to cover and optionally seal an opening in the lid, and a sleeve portion configured to receive the flip-tab. The base portion further comprises a lower base portion configured to fill the area of the lid opening, and an upper base portion configured to rest upon the lid surface. The lower base portion comprises a ridge that spans the perimeter of the lower base portion and facilitates the sealing of a beverage can lid. In an alternate embodiment, the sleeve portion can be separated from, and hingedly attached to, the base portion. The device further comprises a pull handle attached to an end of the sleeve portion.

The pull handle facilitates the opening of the beverage can lid. The device is applied to a beverage can lid by mating the flip-tab with the sleeve portion. Once in place, the lid can be opening by lifting the pull handle away from lid surface to cause a tab lip of the flip-tab to rotate towards the lid surface and act as a lever to punch out a swinging seal in the lid. The pull handle further facilitates rotation of the base portion about the lid surface and into a covering position that covers the lid opening. Finally, the pull handle facilitates the sealing of the lid opening, whereby lowering the handle presses downward on the base portion and locks the base portion into a sealing position. When in the sealing position, the device of the present invention can substantially prevent the loss of carbonation and also prevent liquid from spilling out of the beverage can.

A primary objective of the present invention is to provide a device for opening and re-sealing a flip-tab beverage can lid. Other aspects, features, and advantages of the present invention will become apparent to those persons having ordinary skill in the art to which the present invention pertains from the following description taken in conjunction with the accompanying drawings.

### BRIEF DESCRIPTION OF THE DRAWINGS

The following drawings illustrate embodiments of the present invention:

FIG. 1 is a perspective view illustrating an exemplary embodiment of the device of the present invention.

FIG. 2A illustrates a front view of the device of the present invention looking into the sleeve portion.

FIG. 2B illustrates a side view of the device shown in FIG. 2A.

FIG. 3A is a perspective view of the device of the present invention engaged with the flip-tab of a beverage can lid and in an initial position.

FIG. 3B illustrates a cross-sectional view of taken through the plane designated by line 3B of FIG. 3A.

FIG. 4 is a cross-sectional view of the beverage can in which the pull handle of the device has been lifted to punch out the swinging seal to form an opening in the lid.

FIG. 5 illustrates how the pull handle facilitates the lateral rotation of the sleeve portion and the flip-tab.

FIG. 6 is a perspective view of the beverage can lid with the device of the present invention rotated 180 degrees about the lid surface from the initial position to a covering position that covers the lid opening.

FIG. 7 is a cross-sectional view of the configuration shown in FIG. 6.

FIG. 8A is a cross-sectional view of the beverage can and the device of the present invention in a sealing position.

FIG. 8B is an enlarged cross-sectional view of the sealing mechanism of the present invention shown in FIG. 8A.

FIG. 9 is a perspective view illustrating an exemplary embodiment of the device of the present invention, wherein the lower surface of the sleeve portion extends beyond the upper surface of the sleeve portion.

### DETAILED DESCRIPTION

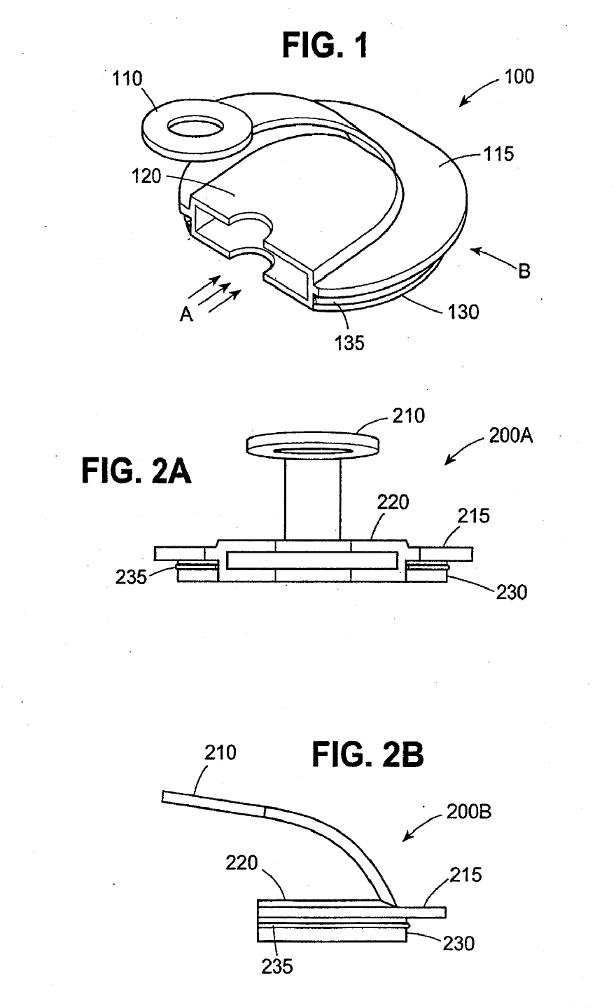

Referring to the drawings in more detail, FIG. 1 illustrates an exemplary embodiment of the present invention, i.e. device 100. Device 100 comprises a pull handle 110, upper base portion 115, sleeve portion 120, and lower base portion 130. As used herein, the phrase “base portion” refers, collectively, to the upper base portions 115 and lower base portion 130. Lower base portion 130 includes a minor outward protrusion running along its perimeter, i.e. ridge 135. Ridge 135 spans the perimeter of lower base portion 130. In an alternate embodiment, base portion 130 may include a plurality of parallel ridges. Pull handle 110 is flexibly connected at the interface between sleeve portion 120 and upper base portion 115. The base portion houses the sleeve portion 120 that is configured to receive the lifting end of a flip-tab found on a conventional beverage can lid. As shown, the sleeve portion includes an upper and lower surface. In an alternate embodiment, the lower surface extends beyond the upper surface to better facilitate the application of the device to the flip-tab of a beverage can lid (as shown in FIG. 9).

FIG. 2A illustrates a view of device 100 from the perspective indicated by arrow A in FIG. 1, i.e. sleeve opening view 200A. Sleeve opening view 200A illustrates pull handle 210, sleeve portion 220, upper base portion 215, lower base portion 230, and ridge 235. As shown, the base portion is tapered such that the upper base portion 215 extends beyond the lower base portion 230 along the entire circumference of the device. Ridge 235 spans the perimeter of lower base portion 230. FIG, 2B illustrates a view of device 100 of FIG. 1 from the perspective indicated by arrow B in FIG. 1, i.e. profile view 200B. Profile view 200B comprises pull handle 210, sleeve portion 220, upper base portion 215, lower base portion 230, and ridge 235. In an alternate embodiment, the lower surface of the sleeve portion extends beyond the upper surface such that the cross section of the sleeve takes on a diagonal shape whereby the sleeve portion can more easily slide beneath and receive the flip-tab (as shown in FIG. 9).

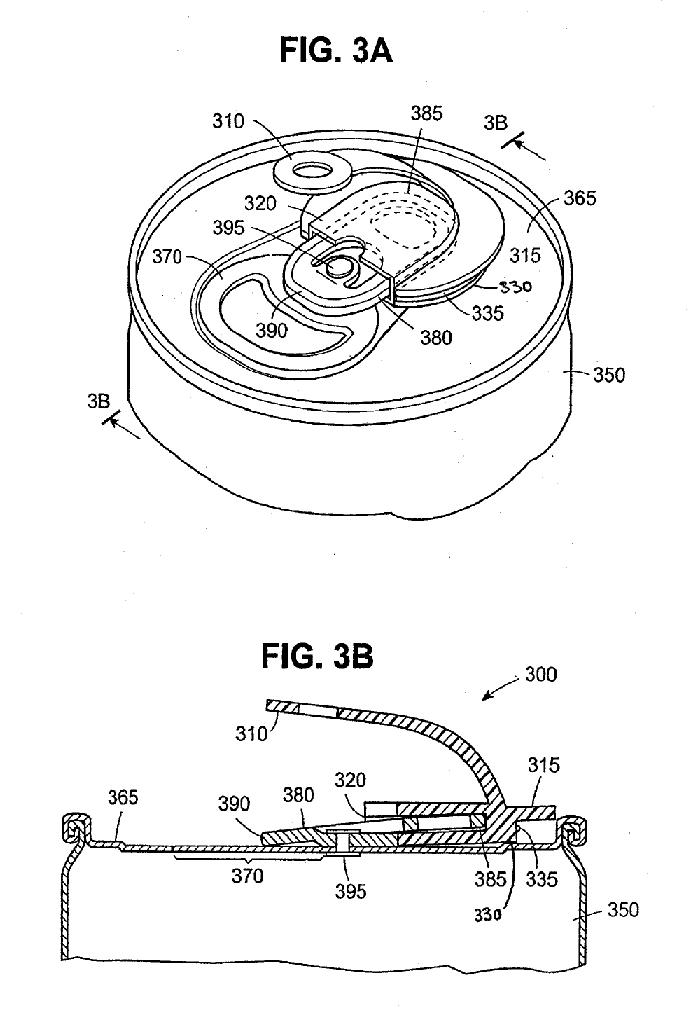

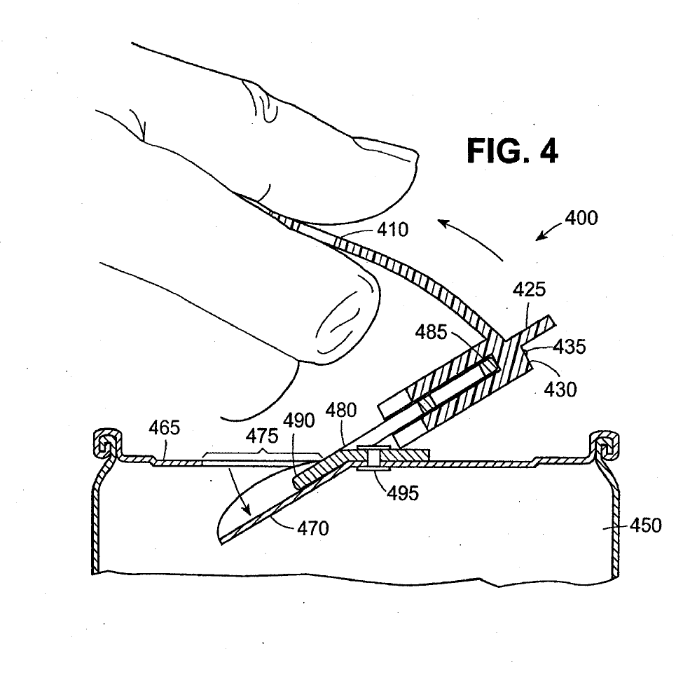

FIGS. 3A and 3B show the device of the present invention in an initial position. FIG. 3A illustrates an exemplary embodiment of the present invention, i.e. device 300, in conjunction with a conventional beverage can 350. Device 300 comprises a pull handle 310, upper base portion 315, lower base portion 330, and a sleeve portion 320. Ridge 335 spans the perimeter of base portion 330. Beverage can 350 comprises a lid surface 365, a swinging seal 370 defined by a scored section, and a flip-tab 380. Flip-tab 380 is attached to lid surface 365 via rivet 395. Flip-tab 380 further comprises a tab handle 385 and a tab lip 390 which are on opposite sides of rivet 395. As shown, sleeve portion 320 is configured to receive tab handle 385 of flip-tab 380, while lower base portion 330 is configured to slide under flip-tab 380 and remain substantially in contact with the lid surface 365. The swinging seal 370 is rotatable from a sealed position (as shown in FIG. 3A) to an unsealed position (as shown in FIG. 4) to expose an opening in the lid through which a user can drink the contents of the beverage can 350. The rivet 395 provides for rotation of flip-tab 380 about lid surface 365. To open beverage can lid 365, a user must lift tab handle 385. When device 300 is lifted upward by applying a tensile force (i.e. pulling) pull handle 310, it causes tab lip 390 to rotate downward about rivet 395. The tab lip 390 acts as a lever to punch the swinging seal 370 out of its sealed position to an unsealed position (shown in FIG. 4). In an exemplary embodiment, the device 300 is made from acetal plastic or other polymeric material that exhibits low moisture absorption and high durability.

FIG. 3B illustrates a cross-sectional view 300B of device 300 taken through the plane designated by line 3B of FIG. 3A. Cross-sectional view 300B includes pull handle 310, upper base portion 315, lower base portion 330, ridge 335, sleeve portion 320, and beverage can 350. Beverage can 350 further comprises lid surface 365, swinging seal 370, flip-tab 380, tab handle 385, tab lip 390, and rivet 395. When device 300 is applied to beverage can lid 365, base portion 330 slides between beverage can lid 365 and flip-tab 380, forcing tab handle 385 of flip-tab 380 to lift upward and slide into sleeve portion 350. Lower base portion 330 remains in contact with lid surface 365.

FIG. 4 shows the opening of a beverage can lid using the device of the present invention, i.e. device 400. A user lifts the device by pulling pull handle 410 as indicated by the arrow. This causes flip-tab handle 485 to rotate upward about rivet 495 and causes tab lip 490 to rotate downward about rivet 495, punching out the swinging seal 470 to form a lid opening 475. In this manner, a user of the present invention can open a beverage can lid without having to wedge their finger and/or nail under the flip-tab handle in order to lift it and open the can. The user can drink the contents of beverage can 450 through opening 475. However, once the swinging seal 470 of a conventional beverage can lid is punched out to form the lid opening, there is no mechanism provided for re-sealing the lid opening. As a result, the carbonation in the liquid contained in the beverage can escapes through the lid opening. Furthermore, the liquid in the beverage can is exposed to a variety of contaminants entering through the lid opening, such as airborne particles and insects. The longer the beverage can lid remains open and unsealed, the greater the risk of contamination and the less enjoyable the beverage becomes due to decreased carbonation.

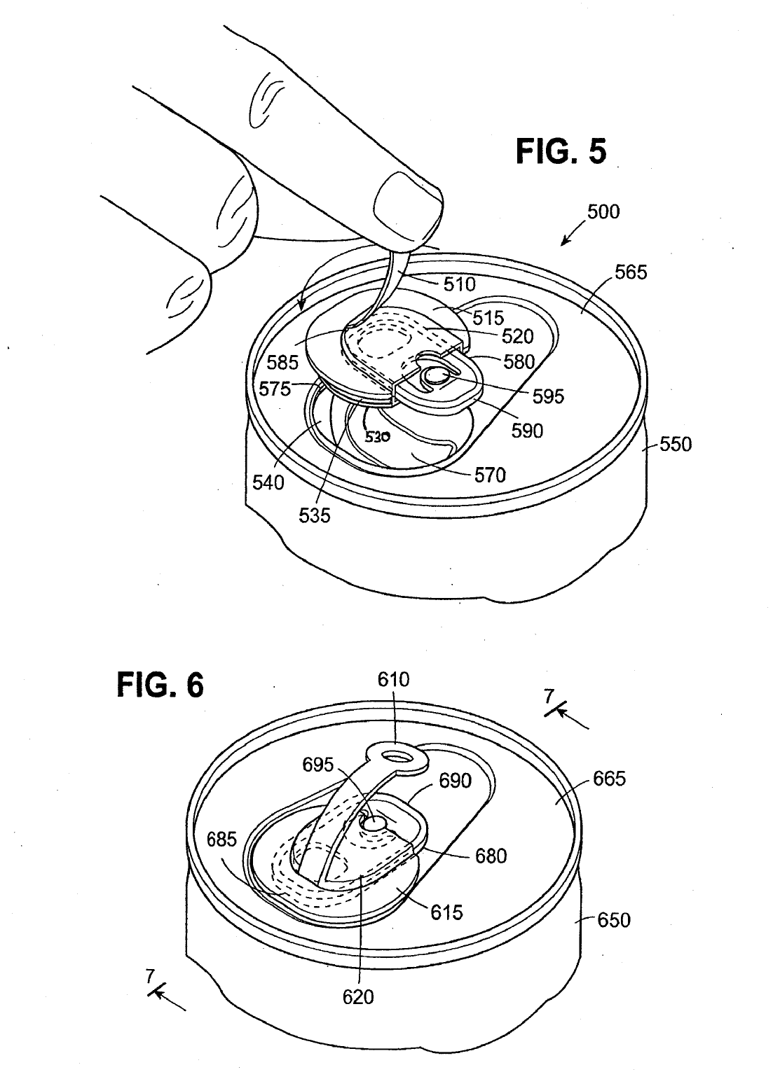

FIG. 5 illustrates how the pull handle facilitates the lateral rotation of the flip-tab about the lid surface and into a covering position that covers the lid opening (as shown in FIG. 6). Device 500 comprises pull handle 510, upper base portion 515, lower base portion 535, and sleeve portion 520. Beverage can 550 comprises a lid surface 565, a swinging seal 570 defined by scored section 575, lid opening 540, and a flip-tab 580. Flip-tab 580 is attached to lid surface 565 via rivet 595. Flip-tab 580 further comprises a tab handle 585 and a tab lip 590 which are on opposite sides of rivet 595. Following FIG. 4, the swinging seal 570 has been punched out of the scored section 575 to form lid opening 540. The lid opening 540 corresponds to lid opening 440 of FIG. 4. By pulling on the pull handle 510 in the direction indicated by the arrow, a user can rotate the device 500 and flip-tab 580 laterally about the rivet 595 on lid surface 565. During the rotation, flip-tab 580 remains securely contained within sleeve portion 520, and base portion 520 remains substantially in contact with the lid surface 565.

FIG. 6 is a perspective view of the beverage can lid with the device of the present invention rotated 180 degrees about the lid surface from the initial position shown in FIG. 3A to a covering position that covers the lid opening. Device 600 comprises pull handle 610, upper base portion 615, and sleeve portion 620. Beverage can 650 comprises lid surface 665, flip-tab 680, tab handle 685, tab lip 690, and rivet 695. The lower base portion (not visible) is configured to completely cover the area of the lid opening (see lid opening 540 of FIG. 5). Similarly, upper base portion 615 is configured such that it extends beyond the area of the lid opening (see lid opening 540 of FIG. 5). When device 600 is in the covering position, the lid opening is covered and the contents of the beverage can 650 are protected from outside contaminants by the lower base portion. Moreover, the rate at which carbonation is lost through the lid opening is substantially decreased as a result of the lid opening being covered by upper base portion 615.

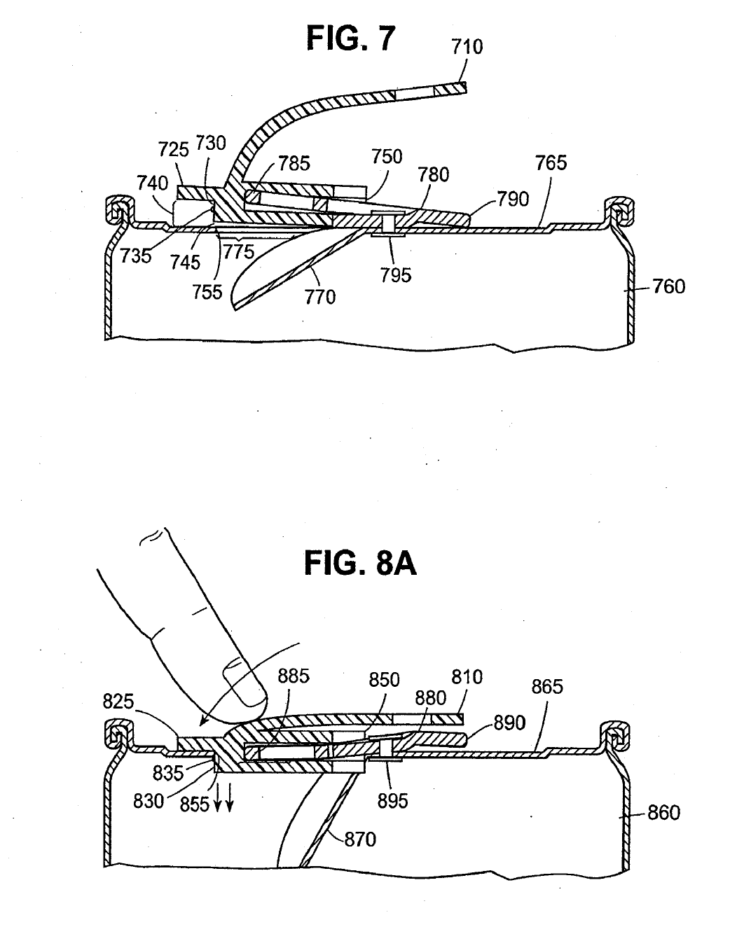

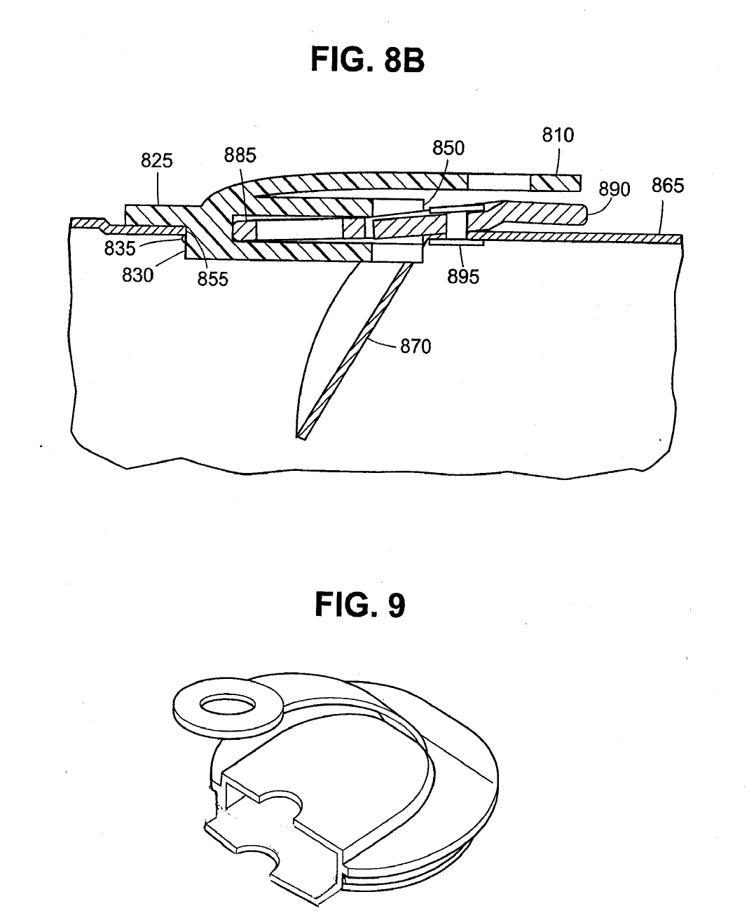

FIG. 7 is a cross-sectional view of the configuration shown in FIG. 6 wherein the device of the present invention is in a covering position. Device 700 comprises pull handle 710, upper base portion 725, lower base portion 730, and sleeve portion 750. Beverage can 760 comprises lid surface 765, lid opening 740, swinging seal 770, lid opening 775, flip-tab 780, tab handle 785, tab lip 790, and rivet 795. As shown, lower base portion 730 covers the entire area of lid opening 775. In the covering position, there is a gap 740 between upper base portion 725 and lid surface 765. Furthermore, base portion 730 spans the entire length of lid opening 775 such that it is vertically aligned with lid opening edge 755. The vertical surface of lower base portion 730 includes ridge 735. In an alternate embodiment, base portion 730 may include a plurality of ridges. As mentioned previously, the covering position keeps the can contents substantially free of contaminants and partially prevents the loss of carbonation. However, due to the presence of gap 745, the beverage can is not completely protected from outside contaminants and from carbonation loss. Therefore, the present invention further provides for a sealing position as shown in FIG. 8A.

FIG. 8A is a cross-sectional view of the beverage can and the device of the present invention in a sealing position. A user can place the device in the sealing position by pushing the device downward (as indicated by the arrow) and snapping the device in place. Specifically, the device is designed such that when the device is depressed, the vertical surface of lower base portion 830 slides past lid opening edge 855 until the lid opening edge comes into contact with ridge 835. As further downward force is applied, ridge 835 and lower base portion 830 are compressed against lid opening edge 855 until ridge 835 moves past the lid opening edge 855. Once ridge 835 moves past lid opening edge 855, the device snaps into place because ridge 835 is securely held between upper base portion 825 and ridge 835 as shown in FIG. 8A. In an alternate embodiment, base portion 830 may include a plurality of ridges. Thus, lower base portion 830 completely fills and seals lid opening 775 (not visible), while upper base portion 825 rests against the lid surface 865. The vertical edge of lower base portion 830 presses against lid opening edge 855 to provide a sustained frictional force than holds the device in the sealing position.

When in the sealing position, the beverage can 860 is kept free from contaminants and the carbonation within the beverage can is substantially preserved because the lid opening is sealed. The user can take the device out of the sealing position by pulling tab handle 810 upward in the direction opposite to that shown by the arrow, thereby lifting base portion 830 out of the lid opening. The unsealing can also be achieved by lifting upper base portion 825 away from the lid surface in the direction opposite the arrow. Once the device is taken out of the sealing position, it remains in the covering position as shown and described in FIGS. 6 and 7. In this manner, a user can repeatedly seal and reseal the beverage can lid as desired. FIG. 8B is an enlarged cross-sectional view of the device of the present invention in the sealing position shown in FIG. 8A. As illustrated, the device is held securely in the sealing position by the wedging of the lid opening edge 855 between ridge 835 and upper base portion 825.

Finally, FIG. 9 shows an embodiment of the present invention wherein the lower surface of the sleeve portion extends beyond the upper surface of the sleeve portion. With this configuration, the sleeve portion of the device can slide beneath the flip-tab more easily and allow the user to apply the device to a beverage can lid with greater speed and ease. To further facilitate the ease and speed of application, the lower surface of the sleeve portion can be configured to have a smaller thickness relative to the upper surface of the sleeve portion. Once the flip-tab is received within the sleeve portion (i.e. the device is in place), the user can open and seal the beverage can as described above.

While the invention has been described with reference to at least one preferred embodiment, it is to be clearly understood by those of ordinary skill in the art that the invention is not limited thereto. Those skilled in the art will understand that the embodiments of the present invention described above exemplify the principles of the invention and do not limit the scope of the invention to those embodiments illustrated and described. The exemplary embodiments provide a foundation from which numerous alternatives and modification may be made that are within the scope and spirit of the present invention as defined in the appended claims. Accordingly, it is intended that the scope of the present invention be defined by the appended claims and their equivalents, rather than by the description of the preferred embodiments.

What is claimed is:

1. A device for opening and sealing a flip-tab beverage can lid, said device comprising:
a base portion configured to cover and optionally seal a lid opening, the lid opening defined by a lid opening edge;
the base portion further comprising an upper base portion and a lower base portion;
a sleeve portion configured to receive the tab handle of a flip-tab; and
a pull handle attached to the base portion, whereby pulling the pull handle lifts the tab handle away from the lid surface and causes a tab lip of the flip-tab to rotate towards the lid surface to punch out a swinging seal in the lid;
the pull handle further facilitating the rotation of the base portion about the lid surface and into a covering position that covers the lid opening, whereby the base portion can then be pressed into a sealing position that seals the lid opening.

2. The device of claim 1 wherein the covering position substantially prevents contaminants from entering the beverage can via the lid opening.

3. The device of claim 1 wherein the sleeve portion, having an upper and lower surface, the lower surface extending beyond the upper surface such that the sleeve portion can more easily slide beneath and receive the flip-tab.

4. The device of claim 1 wherein the lower base portion includes a protruding ridge that spans the perimeter of the lower base portion and interacts with the lid opening edge to facilitate the sealing of the lid opening.

5. The device of claim 1 wherein the sealing position prevents contaminants from entering the lid opening and substantially reduces the loss of carbonation through the lid opening.

6. The device of claim 1 wherein the device is made from a polymeric material such as acetal plastic.

7. The device of claim 1 wherein the device is made of a material that exhibits low moisture absorption and high durability.

8. The device of claim 1 wherein the pull handle comprises a flat, flexible shaft connected to a flat disc or ring that a user can grasp in order to manipulate the device.
